(19) United States
(12) Patent Application Publication
(10) Pub. No.: US 2005/0220091 A1
(43) Pub. Date: Oct. 6, 2005

(54) Secure remote mirroring

(76) Inventors: Bruce Edward LaVigne, Roseville, CA (US); Paul T. Congdon, Granite Bay, CA (US); Mark Gooch, Roseville, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/813,730

(22) Filed: Mar. 31, 2004

(51) Int. Cl. H04L 12/28

(52) U.S. Cl. 370/389

(57) ABSTRACT

One embodiment disclosed relates to a method for remote mirroring of network traffic. A data packet to be remotely mirrored is received by an entry device. The entry device is pre-configured with a destination address to which to mirror the data packet. The packet to be mirrored is encrypted. An encapsulating header is generated and added to encapsulate the encrypted packet. The encapsulating header includes the aforementioned destination address. The encapsulated packet is forwarded to an exit device associated with the destination address, where the packet may be decapsulated, and then decrypted, before being sent out of a port. In another embodiment, the entry and exit devices are remotely configured with encryption and decryption keys, respectively.

### BACKGROUND OF THE INVENTION

1. Field of the Invention

The present invention relates generally to networking and communications technology.

2. Description of the Background Art

Conventional mirroring solutions are highly intrusive to the network administrator, especially in large networks, requiring his/her dispatch to the physical location of the device being monitored. This is because the network analysis device is directly attached to the networking device which needs monitoring. Accordingly, there is great need for a network diagnostic system and method which does not require relocation of diagnostic devices and personnel to the physical location of the device to be monitored.

### SUMMARY

One embodiment of the invention pertains to a method for remote mirroring of network traffic. A data packet to be remotely mirrored is received by an entry device. The entry device is pre-configured with a destination address to which to mirror the data packet. The packet to be mirrored is encrypted. An encapsulating header is generated and added to encapsulate the encrypted packet. The encapsulating header includes the aforementioned destination address. The encapsulated packet is forwarded to an exit device associated with the destination address.

Another embodiment of the invention relates to a networking device. The networking device includes at least a plurality of ports, and a remote mirroring engine, and an encryption module. The plurality of ports receive and transmit packets therefrom. The remote mirroring engine is configured to detect packets from a specified mirror source, to encrypt the detected packets using the encryption module, to encapsulate the encrypted packets, and to forward the encapsulated encrypted packets to a destination by way of at least one of the ports.

Another embodiment of the invention pertains to a system for secure remote mirroring of network traffic. The system includes a mirror entry device and a mirror exit device. The mirror entry device includes a secure mirroring engine configured to detect packets from a specified mirror source, to encrypt the detected packets using an encryption module, encapsulate the encrypted packets, and to forward the encapsulated encrypted packets to a pre-configured destination by way of at least one of the ports. The mirror exit device includes a secure mirroring receiver configured to detect and decapsulate the encapsulated encrypted packets from the mirror entry device and to decrypt the encrypted packets.

In another embodiment, the entry and exit devices are remotely configured with encryption and decryption keys, respectively.

### BRIEF DESCRIPTION OF THE DRAWINGS

FIG. 1 is a schematic diagram depicting an internetworking system across which secure remote mirroring is performed in accordance with an embodiment of the invention.

FIG. 2 is a flow chart depicting a method of secure remote mirroring as performed at an entry device in accordance with an embodiment of the invention.

FIG. 3 is a flow chart depicting a method of secure remote mirroring as performed at an exit device in accordance with an embodiment of the invention.

FIGS. 4A, 4B, and 4C are schematic diagrams depicting, respectively, a data packet to be mirrored, the packet after encryption, and the encrypted packet after encapsulation in accordance with an embodiment of the invention.

FIG. 4D is a schematic diagram depicting an IP-encapsulated encrypted packet with a MAC header in accordance with an embodiment of the invention.

FIG. 5 is a block diagram illustrating an example mirror entry device in accordance with an embodiment of the invention.

FIG. 6 is a block diagram illustrating an example mirror exit device in accordance with an embodiment of the invention.

FIG. 7A is a schematic diagram depicting a secure remote mirroring system utilizing a private key for encryption in accordance with an embodiment of the invention.

FIG. 7B is a schematic diagram depicting a secure remote mirroring system utilizing a public-private key pair for encryption in accordance with an embodiment of the invention.

### DETAILED DESCRIPTION

As mentioned above, in conventional mirroring solutions, the network analysis device is directly attached to the networking device which needs monitoring. This limits the usefulness of the conventional solutions. Remote mirroring overcomes this limitation by allowing for the network monitoring device to be located remotely from the monitored networking device.

Current remote mirroring technologies include Cisco System's Remote Switched Port Analyzer (RSPAN) technology. With RSPAN, packets may be mirrored to a specific RSPAN virtual local area network (VLAN). This allows the monitoring device to be on a different switch from the one being monitored. However, applicants point out that the monitoring device must still be within the OSI layer 2 domain of the traffic which is to be monitored. In addition, the packets are modified from their original format because VLAN tags have been added or replaced. Moreover, RSPAN is insecure in that another device in the layer 2 domain could snoop on the mirrored packets.

Remote mirroring to a destination outside of a layer 2 network may pose further security problems. For example, in accordance with an embodiment of the invention, remote mirroring may be performed to an Internet protocol (IP) destination address (i.e. to a layer 3 address). Such mirroring may cross multiple layer 2 domains before reaching its destination. As such, the security typically provided by physical constraints of a local network may be lost, and the mirrored packets become vulnerable to further security breaches.

In accordance with an embodiment of the invention, the above discussed problems and disadvantages are solved. A remote mirroring solution is provided that does not necessarily require the monitoring device to be located within the layer 2 domain of the traffic which is monitored. Security for the mirrored packets is provided by way of encryption. In one implementation, the mirrored packets preserve their original format. These and other advantages are provided by embodiments of the present invention.

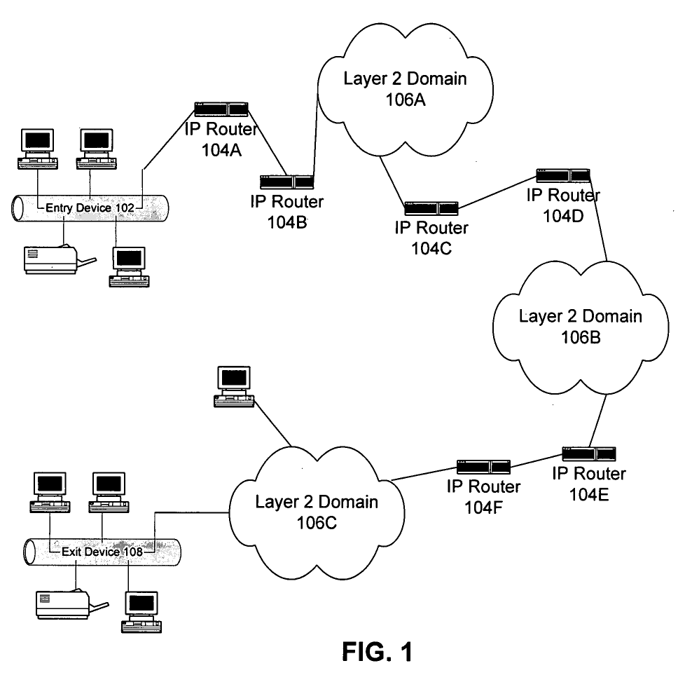

FIG. 1 is a schematic diagram depicting an example of an internetworking system across which secure remote mirroring is performed in accordance with an embodiment of the invention. Of course, FIG. 1 shows just one example configuration for an internetworking system across which secure remote mirroring may be performed in accordance with an embodiment of the invention. The specific configuration in FIG. 1 is for purposes of illustration and discussion. The example internetworking system of FIG. 1 includes a mirror entry device 102, various routers 104, layer 2 domains 106, and a mirror exit device 108.

The mirror entry device 102 may comprise, for example, an appropriately configured switch, router, or other network device. In one particular embodiment, the entry device may comprise an Ethernet type switch as depicted in FIG. 1. Such a switch has multiple ports to connect to various network devices. For example, as illustrated, various ports may be connected to host devices, and a port may connect to an IP router 104A. When packets are destined for IP addresses that are not present in the local layer 2 domain of the entry device, then those packets may be forwarded to their destination via the IP router. Such packets may be forwarded between various routers 104 and across intermediate layer 2 domains 106 in order to reach the exit device 108.

The mirror exit device 108 may comprise, for example, an appropriately configured switch, router, or other network device. A sniffer or analyzer may be coupled to a port of the exit switch or router to examine or analyze the mirrored packets. Alternatively, it is possible that the exit device is itself a computer that functions as a sniffer or analyzer.

In accordance with an embodiment of the invention, the entry and exit devices (102 and 108) may be embodied in a switching product, such as, for example, an HP ProCurve® switch product available from the Hewlett-Packard Company, with corporate offices in Palo Alto, Calif. Of course, the entry and exit devices may also be implemented with switch products from other companies. The entry and exit devices may also be embodied in other networking device products, such as routers and hubs.

One embodiment of the present invention utilizes IP encapsulation of an encrypted packet. This embodiment comprises a layer 3 technique and so may transverse across various layer 2 domains. For example, the IP-encapsulated packets may be remotely mirrored across the pre-existing public Internet. Hence, this embodiment is advantageously compatible with pre-existing intermediate networking gear in between the entry and exit devices. The intermediate networking gear need not be from any particular manufacturer. In other words, end-to-end control between the entry and exit devices is not required to provide security in accordance with an embodiment of the present invention.

In accordance with embodiments of the invention, the entry device may be configured to securely mirror packets from various types of sources. The following types of sources are a few examples. Other source types may also be possible. The mirroring may be configured for either received packets, transmitted packets, or both. A first type of mirror source is traffic received and/or transmitted via a specified port. Mirroring from such a source may be called port-based mirroring. In one implementation, a variable number of source ports may be specified per mirror session. A second type of mirror source is traffic received and/or transmitted to one or more specified VLAN(s). Mirroring from such a source may be called VLAN-based mirroring. The traffic relating to the specified VLAN(s) may be detected by determining whether a packet has a VLAN tag with one or more specified VLAN identifier(s). A third type of source is traffic received and/or transmitted that matches an entry in a media access control (MAC) look-up table (LUT). Mirroring from such a source may be called MAC-based mirroring. In one implementation, a variable number of LUT entries may be programmed per mirror session. A fourth type of source is traffic received and/or transmitted that matches an entry in an IP look-up table. Mirroring from such a source may be called IP-based mirroring. In one implementation, a variable number of look-up table entries may be programmed per mirror session, enabling mirroring for either received packets, transmitted packets, or both. A fifth type of source is traffic transmitted that matches an IP subnet address, an entry in the best matching prefix (BMP) table. Mirroring from such a source may be called subnet-based mirroring. In one implementation, a variable number of BMP table entries may be programmed per mirror session. A sixth type of source is traffic matching an access control list (ACL) entry. Mirroring from such a source may be called ACL-based mirroring. In one implementation, a variable number of ACL entries may be programmed per mirror session. These lookups may be performed for both bridged and routed IP packets.

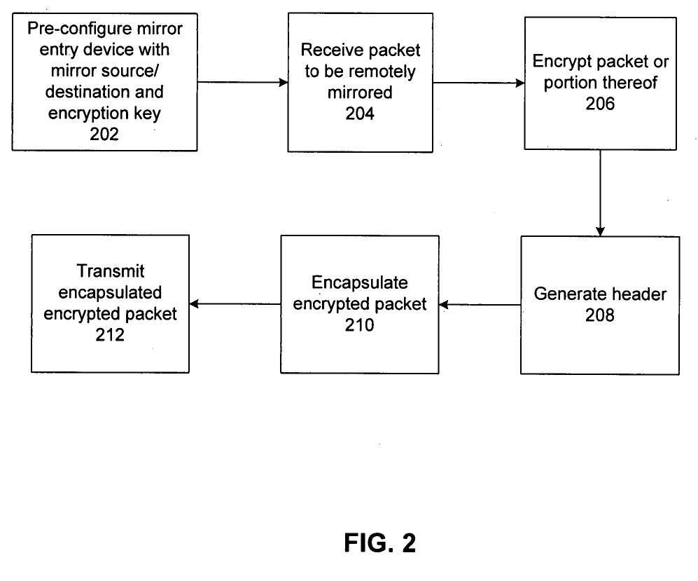

FIG. 2 is a flow chart depicting a method of secure remote mirroring as performed at an entry device in accordance with an embodiment of the invention. Preliminarily, the entry device 102 may be pre-configured 202 with a mirror source and a mirror destination and with an encryption key. The mirror source is the source of the data packets to be mirrored, and the mirror destination is the destination to which the mirror packets are to be securely sent. While the data packets to be mirrored are referred to as “packets,” it is understood that the packets to be mirrored may comprise layer 2 data frames, or layer 3 packets, or other types of data packets.

From whichever mirror source, a packet to be remotely mirrored is received 204 by the entry device 102. In response, the entry device 102 encrypts 206 the data packet or a portion thereof which is desired to be secured.

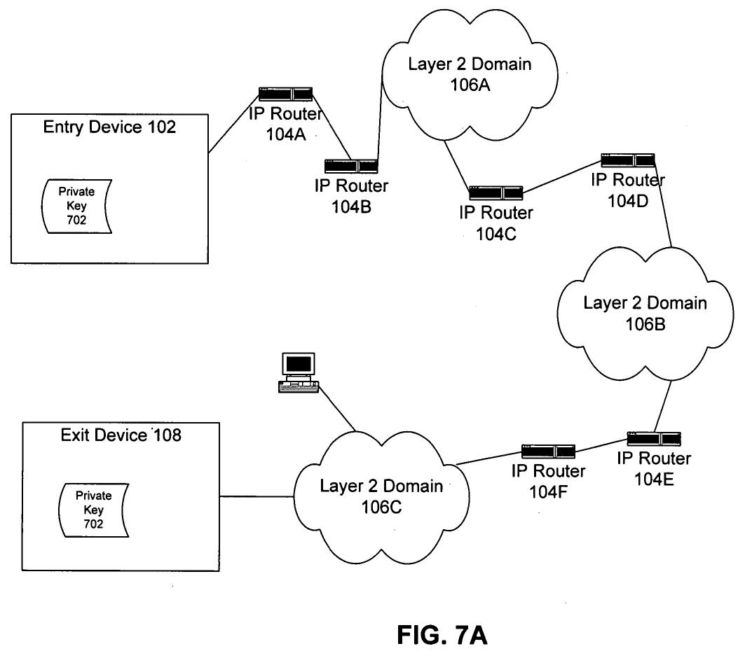

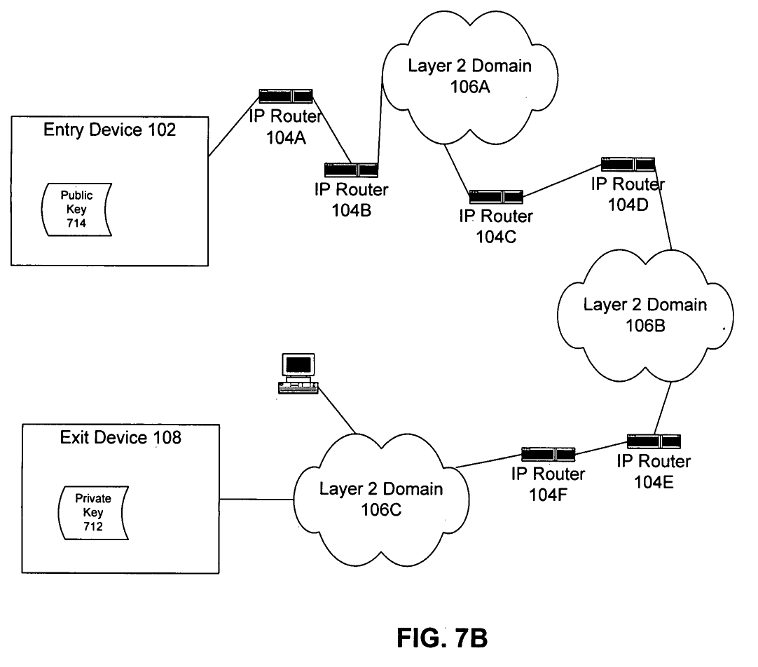

In one embodiment, the encryption 206 may utilize a form of private key encryption where both the entry and exit devices know the private (secret) key or keys used to encrypt the data. Such a system is illustrated in FIG. 7A. In one implementation, the private key encryption may comprise a triple-DES (Data Encryption Standard) algorithm.

In another embodiment, the encryption 206 may utilize a form of public key encryption which scramble the data using a pair of keys. A public key is used for encrypting the data, and a corresponding private key is used for decrypting the encrypted data. Such a system is illustrated in FIG. 7B. In one implementation, the public key encryption may comprise the RSA Data Security system. Advantageously, public key encryption may be used to avoid the need to securely exchange a secret key.

A header is generated 208 and used to encapsulate 210 the encrypted packet. The encapsulated encrypted packet is subsequently transmitted or forwarded 212 towards the mirror exit device 108.

In one embodiment, the header comprises an Internet Protocol (IP) header such that the encapsulation 208 comprises IP encapsulation. IP encapsulation advantageously enables remote mirroring where the mirror exit device 108 may be located outside the layer 2 domain of the mirror entry device 102. Such transmission over multiple layer 2 domains (for example, over the public Internet) poses a security issue. However, as described herein, an embodiment of the invention advantageously overcomes the security issue by way of encrypting the mirrored packet prior to mirroring it and correspondingly decrypting the encrypted mirrored packet.

The transmission over a layer 2 domain may occur as follows. A media access control (MAC) address associated with the destination IP address is determined. For example, if a mapping of the destination IP address to the MAC address is stored in an address resolution protocol (ARP) cache, then the MAC address is retrieved from the ARP cache. If not, then an ARP request with the destination IP address may be broadcast, and an ARP reply with the corresponding MAC address may be received. Using the MAC address, a MAC header is generated and added to the IP-encapsulated packet to form a MAC data frame, wherein the MAC header includes the MAC address in a destination field. The MAC data frame is then transmitted to communicate the IP-encapsulated packet across the layer 2 domain.

One implementation involves setting the “do not fragment” bit (flags bit 0x02) in the IP header so that the IP-encapsulated packet is not broken down and transmitted in separate fragments. This ensures that the mirrored packet will be forwarded in a single IP-encapsulated packet. In another implementation, the “do not fragment” bit may be cleared to allow for fragmentation of the mirrored packet. In one implementation, an incrementing identifier is included in the generated IP header. This identifier may be used to determine whether mirrored packets arrive at the exit point in order and without drops. In addition, the identifier may be used to re-order the mirrored packets so that a sniffer or analyzer connected to the exit device can see the packets in the order they were received at the entry point.

In another embodiment, the header comprises a media access control (MAC) header such that the encapsulation 208 comprises MAC encapsulation. MAC encapsulation is advantageously easier to configure than IP encapsulation, but MAC encapsulation limits the mirror entry and exit devices to the same layer 2 domain.

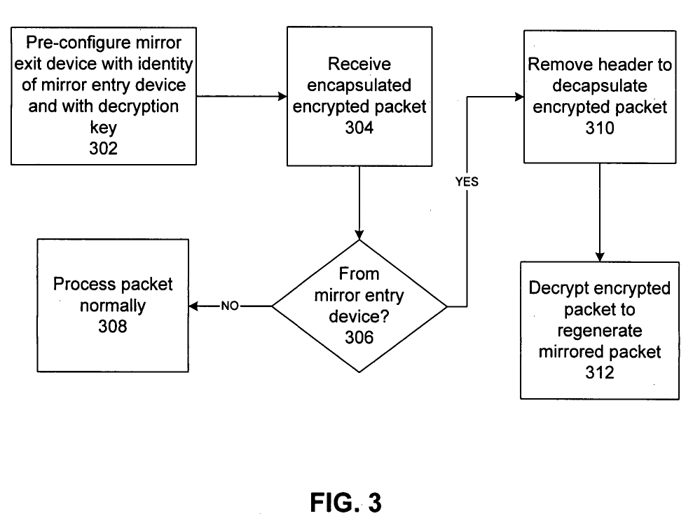

FIG. 3 is a flow chart depicting a method of secure remote mirroring as performed at an exit device in accordance with an embodiment of the invention. Preliminarily, the mirror exit device 108 may be pre-configured 302 with a decryption key and an identity of a mirror entry device 102. The mirror entry device 102 may be identified, for example, by an IP address if IP encapsulation is being used to implement the remote mirroring. The decryption key depends on the encryption performed at the mirror entry device 102. In one embodiment, the key comprises a same private key as used by the entry device 102 to encrypt 206 the data in the mirrored packet under a private key encryption system. In that case, the private key is preferably exchanged between the entry and exit devices in a secure technique. In another embodiment, the key comprises the private key corresponding to the public key used by the entry device 102 to encrypt 206 the data in the mirrored packet under a public key encryption system.

The mirror exit device 108 receives 304 data packets. A determination 306 is made by the mirror exit device 108 as to whether a packet received is from the mirror entry device 102. If the packet is not from the mirror entry device 102, then the packet may be processed 308 normally (i.e. without decapsulation and without decryption). On the other hand, if the packet is determined to be from the mirror entry device 102, then the packet is processed by removing 310 the encapsulating header to decapsulate the encrypted packet, and then by decrypting 312 the encrypted packet to regenerate the mirrored data packet.

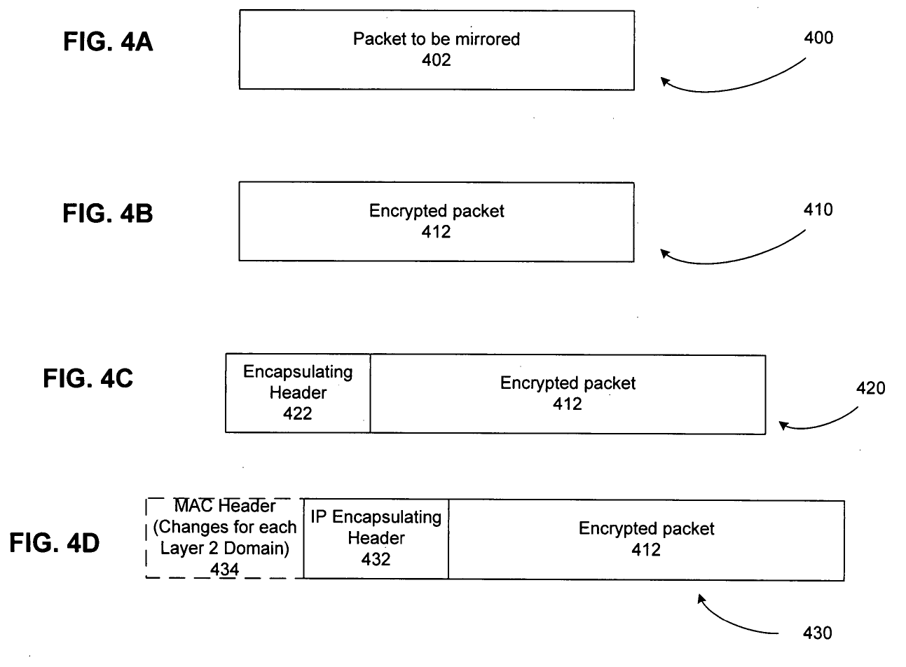

FIGS. 4A, 4B, and 4C are schematic diagrams depicting, respectively, a data packet to be mirrored, the packet after encryption, and the encrypted packet after encapsulation in accordance with an embodiment of the invention. The data packet to be mirrored 402 of FIG. 4A is encrypted 206 to form the encrypted packet 404 of FIG. 4B. A header 422 is added 210 to the encrypted packet 412 of FIG. 4B to generate the encapsulated encrypted packet 420 of FIG. 4C.

FIG. 4D is a schematic diagram depicting an IP-encapsulated encrypted packet with a MAC header in accordance with an embodiment of the invention. Here the encapsulating header 422 comprises an IP header 432. Such IP encapsulation advantageously enables mirroring of the encrypted packet across multiple layer 2 domains. As the IP encapsulated packet crosses a layer 2 domain, an appropriate MAC header 434 to traverse that domain is added in front of the IP encapsulating header 432. The MAC header 434 is temporary in that it changes for each layer 2 domain.

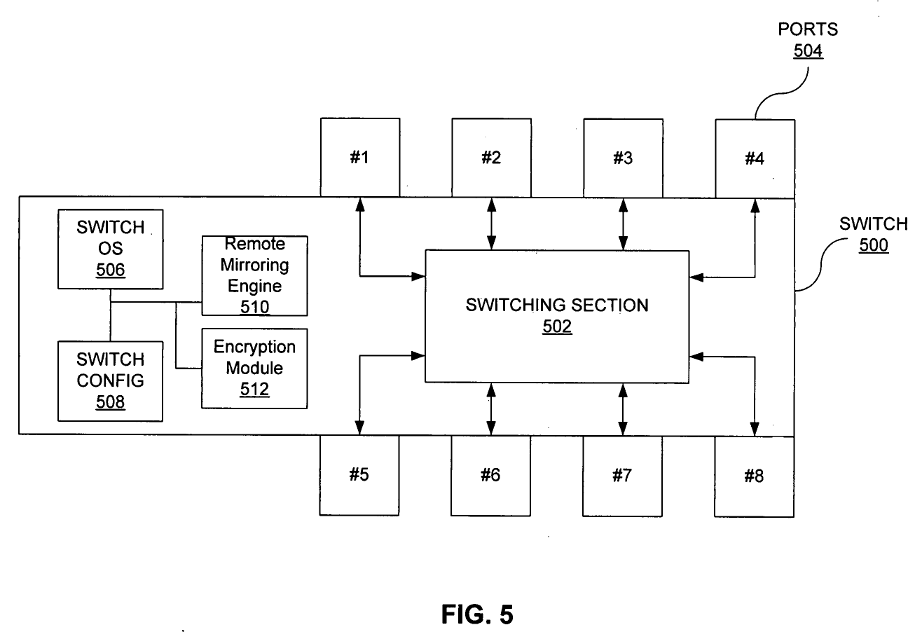

FIG. 5 is a block diagram illustrating an example mirror entry device in accordance with an embodiment of the invention. In this example, the mirror entry device 102 comprises a network switch 500. The switch 500 includes a switching section 502, a plurality of switch ports 504, a switch operating system (OS) 506, a switch configuration 508, a remote mirroring engine 510, and an encryption module 512.

The switching section 502 is coupled to each of the ports 504. The switching section may include, for example, a switching core such as a crossbar switch or other circuitry, and makes connections between the ports 504 so that data frames can be transferred from one port to another port. Eight switch ports 504 are shown in this example. The ports 504 are shown as numbered, for example, as #1, #2, #3, #4, #5, #6, #7, and #8. Of course, other implementations may include any number of ports.

The switch OS 506 includes software routines used to control the operation of the switch 500. The switch configuration file 508 includes configuration information utilized by the switch OS 506. For example, the switch configuration file 508 may include the configuration data for the mirroring source, the destination address of the mirror exit device, and an encryption key to secure the mirrored data.

The remote mirroring engine 510 includes circuitry and logic configured to implement the secure remote mirroring in accordance with an embodiment of the invention. For example, the remote mirroring engine 510 is configured to detect packets from a specified mirror source, to encrypt the detected packets, to encapsulate the encrypted packets, and to forward the encapsulated encrypted packets to a pre-configured destination by way of at least one of the ports. The encryption module 512 is configured to be utilized by the remote mirroring engine 510 during encryption of the detected packets.

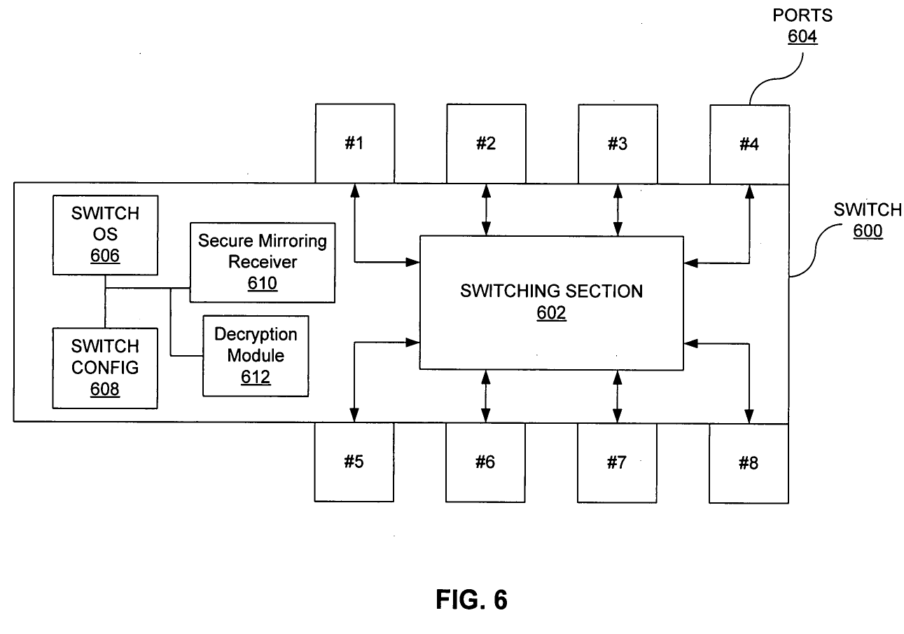

FIG. 6 is a block diagram illustrating an example mirror exit device in accordance with an embodiment of the invention. In this example, the mirror entry device 108 comprises a network switch 600. The switch 600 includes a switching section 602, a plurality of switch ports 604, a switch OS 606, a switch configuration 608, a decapsulation routine 610, and a decryption module 612.

Like in the switch 500 of FIG. 5, the switching section 602 is coupled to each of the ports 604. The switching section may include, for example, a switching core such as a crossbar switch or other circuitry, and makes connections between the ports 604 so that data frames can be transferred from one port to another port. Eight switch ports 604 are shown in this example. The ports 604 are shown as numbered, for example, as #1, #2, #3, #4, #5, #6, #7, and #8. Of course, other implementations may include any number of ports.

The switch OS 606 includes software routines used to control the operation of the switch 600. The switch configuration file 608 includes configuration information utilized by the switch OS 606. For example, the switch configuration file 608 may include the configuration data for the mirroring source and a decryption key to unscramble the mirrored data.

The secure mirroring receiver 610 includes circuitry and logic configured to implement the secure remote mirroring in accordance with an embodiment of the invention. For example, the secure mirroring receiver 610 is configured to decapsulate the encapsulated encrypted packets from the mirror entry device and to decrypt the encrypted mirrored packets. The decryption module 612 is configured to be utilized by the secure mirroring receiver 610 during decryption of the packets.

Note that, in accordance with one embodiment of the invention, a single device may include capabilities to act either as a secure mirror entry device, or as a secure mirror exit device, or as both simultaneously. Such a device would be configured appropriately depending on the application.

FIG. 7A is a schematic diagram depicting a secure remote mirroring system utilizing a private key for encryption in accordance with an embodiment of the invention. Like FIG. 1, the example internetworking system of FIG. 7A includes a mirror entry device 102, various routers 104, layer 2 domains 106, and a mirror exit device 108. In the embodiment depicted in FIG. 7A, both the mirror entry device 102 and the mirror exit device 108 include a same private key 702. The private key 702 is utilized in a private key encryption scheme to provide secure remote mirroring as described above.

FIG. 7B is a schematic diagram depicting a secure remote mirroring system utilizing a public-private key pair for encryption in accordance with an embodiment of the invention. The embodiment depicted in FIG. 7B includes a mirror exit device 108 configured with a private key 712 of a public-private key encryption system. The mirror entry device 102 is configured with the public key 714 associated with the private key 712.

In accordance with an embodiment of the invention, a best effort mode may be enabled or disabled at the entry device 102 for the remote mirroring. Typically, using a best effort mode for the mirrored traffic will prevent head-of-line blocking issues. This is especially true if the mirror link is overloaded with traffic. However, in other circumstances, for example, if the mirrored traffic is known to be light but bursty, it may be desirable to disable the best effort mode (and to enable a lossless mode). In that case, the risk of head-of-line blocking is taken in order to be assured that all traffic is correctly mirrored.

In certain circumstances, the remote mirroring traffic may transverse across a packet-size limited network. The encapsulated packet may be larger than the maximum packet size allowed by such a network. In accordance with an embodiment of the invention, that problem may be circumvented by configuring the entry device 102 to truncate the payload of the packet prior to transmission such that the encapsulated packet is within the allowed size limitations.

In other circumstances, the remote mirroring traffic may transverse across a bandwidth-constrained network. In accordance with an embodiment of the invention, the bandwidth-constraint problem may be alleviated by configuring the entry device 102 to compress the packet (or a portion thereof) prior to encryption so as to reduce the size of the encapsulated packet. In addition, the exit device 108 may be configured to de-compress the packet (or portion thereof) to re-constitute the mirrored packet.

In accordance with one embodiment of the invention, the entry and/or exit devices may be configured to receive the encryption-related keys remotely. For example, simple network management protocol (SNMP) may be utilized to write the encryption and/or decryption keys to the entry and/or exit devices. As another example, a secure remote protocol may be used to write the encryption and/or decryption keys to the entry and/or exit devices. Advantageously, this allows the devices to be configured for secure remote mirroring without the operator having to directly access the devices.

In the above description, numerous specific details are given to provide a thorough understanding of embodiments of the invention. However, the above description of illustrated embodiments of the invention is not intended to be exhaustive or to limit the invention to the precise forms disclosed. One skilled in the relevant art will recognize that the invention can be practiced without one or more of the specific details, or with other methods, components, etc. In other instances, well-known structures or operations are not shown or described in detail to avoid obscuring aspects of the invention. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined by the following claims, which are to be construed in accordance with established doctrines of claim interpretation.

1. A method for secure remote mirroring of network traffic, the method comprising:
receiving a data packet to be remotely mirrored by an entry device pre-configured with a destination address to which to mirror the data packet;
encrypting the data packet to form an encrypted packet;
generating and adding a header to encapsulate the encrypted data packet, wherein the header includes the destination address; and
forwarding the encapsulated encrypted packet to an exit device associated with the destination address.

2. The method of claim 1, wherein the destination address comprises an Internet protocol (IP) destination address, wherein the header comprises an IP header; and wherein the encapsulated encrypted packet comprises an IP-encapsulated encrypted packet.

3. The method of claim 1, wherein the destination address comprises a media access control (MAC) destination address, and wherein the header comprises a MAC header, and wherein the encapsulated encrypted packet comprises a MAC-encapsulated encrypted packet.

4. The method of claim 2, further comprising:
determining a media access control (MAC) address associated with the destination IP address;
generating and adding a MAC header to the IP-encapsulated packet to form a MAC data frame, wherein the MAC header includes the MAC address in a destination field; and
transmitting the MAC data frame to communicate the IP-encapsulated packet across a layer 2 domain.

5. The method of claim 4, wherein determining the MAC address comprises:
determining if a mapping of the destination IP address to the MAC address is stored in an address resolution protocol (ARP) cache;
if so, then retrieving the MAC address from the ARP cache; and
if not, then broadcasting an ARP request with the destination IP address and receiving an ARP reply with the MAC address.

6. The method of claim 4, wherein the IP-encapsulated packet is communicated across multiple intermediate layer 2 domains.

7. The method of claim 1, further comprising:
receiving the encapsulated encrypted packet by the exit device;
removing the header to de-encapsulate the encrypted packet; and
decrypting the encrypted packet to re-generate the data packet.

8. The method of claim 7, wherein the encrypting and decrypting is performed under a public-private key encryption scheme.

9. The method of claim 8, wherein the encrypting is performed using a public key of a destination device, and wherein the decrypting is performed using a corresponding private key of the destination device.

10. The method of claim 1, further comprising:
configuring the entry device in a best effort mirroring mode to reduce head-of-line blocking.

11. The method of claim 1, further comprising:
configuring the entry device in a lossless mirroring mode to assure completeness of mirrored traffic.

12. The method of claim 1, further comprising:
truncating the data packet to reduce a size of the data packet prior to encryption thereof.

13. The method of claim 1, further comprising:
compressing at least a portion of the data packet to reduce a size of the data packet prior to encryption thereof.

14. A networking device comprising:
a plurality of ports for receiving and transmitting packets therefrom;
a secure remote mirroring engine configured to detect packets from a specified mirror source, to encrypt the detected packets, to encapsulate the encrypted packets, and to forward the encapsulated encrypted packets to a pre-configured destination by way of at least one of the ports; and
an encryption module configured to be utilized by the remote mirroring engine during encryption of the detected packets.

15. The networking device of claim 14, wherein the destination comprises an Internet protocol (IP) destination address.

16. The networking device of claim 15, wherein the remote mirroring engine encrypts the packets using a public key of a public-private key pair.

17. A system for secure remote mirroring of network traffic, the system comprising:
a mirror entry device including a secure mirroring engine configured to detect packets from a specified mirror source, to encrypt the detected packets using an encryption module, encapsulate the encrypted packets, and to forward the encapsulated encrypted packets to a pre-configured destination by way of at least one of the ports; and
a mirror exit device including a secure mirroring receiver configured to detect and decapsulate the encapsulated encrypted packets from the mirror entry device and to decrypt the encrypted packets.

18. The system of claim 17, wherein the encrypting and decrypting is performed under a public-private key encryption scheme.

19. The system of claim 18, wherein the encrypting is performed using a public key of a destination device, and wherein the decrypting is performed using a corresponding private key of the destination device.

20. A system for secure remote mirroring of network traffic, the system comprising a mirror entry device including means to encrypt the detected packets using an encryption module and to encapsulate the encrypted packets; and a mirror exit device including means to decapsulate the encapsulated encrypted packets from the mirror entry device and to decrypt the encrypted packets.

21. A method for secure remote mirroring of network traffic, the method comprising:
remotely configuring an entry device with an encryption key and destination address;
remotely configuring an exit device at the destination address with a decryption key;
receiving a data packet to be mirrored by the entry device;
encrypting the data packet using the encryption key to form an encrypted packet;
generating and adding a header to encapsulate the encrypted data packet, wherein the header includes the destination address; and
forwarding the encapsulated encrypted packet to the exit device.

22. The method of claim 21, wherein the remote configuration is performed by way of SNMP.

23. The method of claim 21, wherein the remote configuration is performed by way of a secure remote protocol.
